(19) United States
(12) Patent Application Publication
(10) Pub. No.: US 2024/0067087 A1
(43) Pub. Date: Feb. 29, 2024

(54) VEHICLE DIGITAL ALERTING SYSTEM

(71) Applicant: ESS-HELP, INC., Houston, TX (US)

(72) Inventors: DAVID M. TUCKER, Katy, TX (US); STEPHEN T. POWERS, Houston, TX (US); MIKE INCORVAIA, Hendersonville, TN (US); AUSTIN REECE TUCKER, Katy, TX (US)

(21) Appl. No.: 18/238,809

(22) Filed: Aug. 28, 2023

Related U.S. Application Data
(60) Provisional application No. 63/401,484, filed on Aug. 26, 2022.

(51) Int. Cl. B60Q 11/00; B60R 21/013; H04W 4/90

(52) U.S. Cl. CPC B60Q 11/00; B60R 21/013; H04W 4/90

(57) ABSTRACT

A microprocessor in a vehicle receives an indication of a hazard event associated with the vehicle and transmits and alerts to a safety alert system. The safety alert system may forward the alert to additional vehicles based upon a number of factors.

### CROSS-REFERENCE TO RELATED CASES

This application claims the benefit of U.S. provisional patent application Ser. No. 63/401,484, filed on Aug. 26, 2022, and incorporates such provisional application by reference into this disclosure as if fully set out at this point.

### FIELD OF THE INVENTION

This disclosure relates to communication of emergency conditions with respect to vehicles generally and, more specifically, to automated and electronic communication of emergencies, hazards, and other events between vehicles, or between vehicles and other receivers.

### BACKGROUND OF THE INVENTION

Systems exist that provide enhanced visual communications systems for vehicles that are in distress, breakdown, or emergency states. Enhanced visual communications systems may also be deployed when a vehicle has had an airbag activation or activation of traction control, ABS, or a similar automatic safety system. Enhanced visual communications systems may rely on increased flash rates (e.g., strobing) of vehicle signal lights or other lights that may include auxiliary lights or remote beacons. Various flashing patterns may be utilized in a manner designed to attract attention or communicate more effectively than with older slow speed standard hazard flasher systems. Examples of such enhanced visual communication systems utilizing vehicle signal lamps are described in U.S. Pat. No. 9,481,331 to Tucker, et al. and U.S. Pat. No. 9,616,810 to Tucker, et al.

Although enhanced visual communication systems relying only on strobing lights or other visual enhancements serve well to inform other drivers in proximity to the distressed vehicle that caution should be exercised, they are necessarily limited in their ability to inform drivers who may be too far away, behind other vehicles, around curves or bends in the road, or inhibited by other obstructions. Enhanced visual communication systems also still rely on at least some amount of attention being paid by other drivers, as well as their reaction time and ability to properly assess an emergency or distress visual communication, and to react appropriately.

Moreover, it would remain up to the individual driver to know how and when to deploy their own safety systems that may serve to mitigate the chance of further distress events (e.g., collisions) or to appropriately signal other traffic around them. It will occasionally be observed that a driver will activate his or her emergency flashers upon encountering another vehicle in distress or another emergency situation in order to pre-emptively alert drivers behind or near him or her. Although helpful, this is far from universal. Additionally, mere activation of hazard lights cannot provide information to drivers who are out of sight of the original event and do not know what is happening or how to respond. For example, in some cases it would be appropriate to continue, but with increased caution (e.g., animals on the roadside), while in other cases the best response would be to stop entirely (e.g., an overturned gasoline truck ahead).

Cars that are partially or completely self-driving are already a reality and are predicted to become commonplace. Computer vision, radar, GPS and other technologies are deployed to make self-driving cars as aware of their surroundings as possible in order to safely drive on streets and highways. Statistically, self-driving cars may already be safer than human drivers. However, a self-driving car must still presently “see” or “hear” a distress event of another car on the road in much the same manner as a human driver. They can “watch” for events that might be indicative of caution or distress, but they are limited by line of sight, other vehicles, obstructions, etc.

What is needed is a system and method for addressing the above and related concerns.

### SUMMARY OF THE INVENTION

The invention of the present disclosure, in one aspect thereof, comprises a system for communicating alerts to or from a passenger vehicle. The system includes a microprocessor in the vehicle receiving an indication of a hazard event associated with a first passenger vehicle and generating an alert in response thereto, and a transmitter used by the microprocessor to forward the alert wirelessly to a safety alert system that forwards the alert to one or more additional passenger vehicles determined to be in an approach zone to a location where the microprocessor received the indication of the hazard event.

In some cases, the hazard event comprises an indication that the first passenger vehicle is not safely operable. In some cases, the hazard event comprises an indication of damage to the passenger vehicle. The indication of the hazard event may originate from a passenger vehicle safety system. The indication of the hazard event may be from an occupant of the passenger vehicle.

The alert can include data corresponding to the location of the passenger vehicle. The alert may include data corresponding to an orientation of the passenger vehicle.

In some cases, the microprocessor generates and sends to the safety alert system via the transmitter an additional alert containing additional information related to the hazard event. The transmitter may be a radiofrequency transmitter.

The invention of the present disclosure, in another aspect thereof, comprises a method including providing a safety alert server in communication with a plurality of passenger vehicles, receiving at the safety alert server from a first of the plurality of passenger vehicles an indication that the first passenger vehicle has encountered a hazard and a location of the first passenger vehicle, obtaining location and heading information at the safety alert server from at least some of the plurality of passenger vehicles apart from the first of the plurality of passenger vehicles, and determining at the safety alert server if any of the at least some of the plurality of passenger vehicles apart from the first of the plurality of passenger vehicles is within a predetermined distance of and headed toward the first of the plurality of passenger vehicles, and if so, sending an alert to such of the at least some of the plurality of passenger vehicles apart from the first of the plurality of passenger vehicles.

The method may include delivering the alert via the internet and/or delivering the alert wirelessly. The method can include sending the alert from the safety alert server to a cloud computing platform and/or sending the alert from the safety alert server to an emergency responder service.

In some embodiments, the method further includes receiving at the safety alert server an indication of a hazard at a fixed location not originating from a passenger vehicle, and determining at the safety alert server if any of the at least some of the plurality of passenger vehicles is within a predetermined distance of and headed toward the fixed location, and, if so, sending a notification to such of the at least some of the plurality of passenger vehicles.

The method may further include obtaining at the safety alert server driving characteristic data from at least a subset of the plurality of passenger vehicles, determining by the safety alert server an inferred hazard location based on the received driving characteristic data, and sending an alert from the safety alert server to at least one of the plurality of passenger vehicles with a heading in a direction of the inferred hazard location.

The invention of the present disclosure, in another aspect thereof, comprises a system including a first a microprocessor in a first passenger vehicle, and a safety alert system having a communicative coupling to the first microprocessor. The first microprocessor provides location data regarding the vehicle to the safety alert system. The safety alert system sends an inbound safety alert to the first microprocessor when the location data indicates the first passenger vehicle is nearing a safety hazard.

In some cases, the safety alert system is notified of the safety hazard by a second passenger vehicle to which is it communicatively coupled. The first microprocessor may issue a command to the vehicle to disengage a driving assist feature and provide a notice to a driver of the vehicle when the inbound safety alert is received. The first microprocessor can be communicatively coupled to a safety system of the first passenger vehicle, and in response to an indication of a vehicle safety hazard send an outbound alert to the safety alert system.

### BRIEF DESCRIPTION OF THE DRAWINGS

FIG. 1 is a schematic diagram of a vehicle emergency communication system according to aspects of the present disclosure.

FIG. 2 is a communication link diagram of a one embodiment of vehicle emergency communication system according to aspects of the present disclosure.

FIG. 3 is a communication link diagram of another embodiment of an emergency communication system link diagram according to aspects of the present disclosure.

FIG. 4 is a diagram illustrating potential relationships between driving and disabled vehicles on a road network.

FIG. 5 is a flow chart corresponding to one method of operation of an emergency vehicle communication system according to aspects of the present disclosure.

FIG. 6 is a system level diagram of a vehicle signaling system according to aspects of the present disclosure.

FIG. 7 is an exemplary diagram of a format of an outbound alert from a vehicle according to aspects of the present disclosure.

FIG. 8 is an exemplary diagram of a format of an inbound alert to a vehicle from an alert management system according to aspects of the preset disclosure.

FIG. 9 is an exemplary diagram of a various communication links between systems of the present disclosure.

FIG. 10 is a diagram of a geofenced alert distribution according to aspects of the present disclosure.

### DETAILED DESCRIPTION OF THE PREFERRED EMBODIMENTS

According to the present disclosure, various systems and methods are provided that enable digital transmission of alerts from a vehicle, or a personal electronic device associated with a vehicle, to other vehicles, operators or passengers of such vehicles, personal electronic devices, self-driving vehicles and their passengers, emergency services, traffic tracking and control systems, and remote servers or cloud-based computing systems. For purposes of the present disclosure a remote server is a known system, or may otherwise any computing device not present within a vehicle or personal electronic device associated with the vehicle, and which can be communicated with from the vehicle by any known method. A server may include multiple redundant servers and cloud-based services. Servers and remote servers may include remote computing systems that are not necessarily part of a cloud services suite per se. A cloud-computing system may be a known system or may otherwise comprise a remote server or a distributed network of remote servers or computers that can receive and send communications from/to a vehicle or a personal electronic device associated with the vehicle by any known method. Various degrees of security may be implemented and may have some impact on the type and location of server used.

An alert may correspond merely to information being provided to/from the vehicle, an occupant, or a personal electronic device, but, according to the present disclosure, an alert may indicate a road hazard, a disabled vehicle, or other event that would be beneficial if known to drivers. For purposes of the present disclosure, a driver should be understood to be a person (in the case of a traditional manually operated vehicle), but can also comprise whatever computer(s) or control device(s) is/are partially or completely responsible for operation of the subject vehicle, whether such computer or device is considered a driver assist features (e.g., cruise control or lane keeping), a full self-driving vehicle or system, a system with capabilities in between these examples.

An alert may be considered, for example, an emergency alert, a disabled vehicle alert, road hazard alert, a road closure alert, a traffic alert, or another type of alert. Unless otherwise specified, an alert should be considered to be any notification of any useful information to or from a vehicle or a driver or passenger of the vehicle. Systems of the present disclosure may communicate information relating to the vehicle generating or sending the alert, or other conditions or information. This information may be considered part of the alert in some embodiments. For purposes of the present disclosure, an alert, alerting, sending an alert, and similar phrases should be taken to mean communication of the alert.

Some systems and methods according to the present disclosure provide for communications or alerts where the originator of the alert and the final intended recipient are both vehicles (or persons or devices associated therewith). Such a system may be referred to as a vehicle-to-vehicle communication system (e.g., V2V). In other embodiments, instead of, or in addition to V2V functionality, the system or method may include communications or alerts to/from a vehicle and another system or device that is not a vehicle. Such non-vehicle originators or recipients may include emergency services, traffic monitoring systems, streetlights, toll collection systems, and others. Systems of the present disclosure providing for such alerting may be referred to as vehicle-to-everything or vehicle-to-environment systems (e.g., V2X).

It should be understood that the terms vehicle, car, automobile and similar are intended to refer to any conveyance operating on a roadway. This includes, without limitation, cars, trucks, vans, SUVs, tractor/trailers, buses, and motorcycles, whether auto piloted or manually driven and whether carrying passengers, or goods, or being empty.

It should also be understood that, for purposes of the present disclosure, a wireless signal or communication may be an intermittent or an ongoing/continuous signal or communication. A wireless signal may comprise an analog and/or digital communication unless otherwise specific. Any one digital wireless communication or signal may comprise a number of smaller digital communications or signals that are broken down for transmission and reassembled by the receiver to complete the original communication or signal, as known in the art.

The present disclosure provides various embodiments of systems and methods that provide for alerts from one vehicle to another regarding hazardous conditions or other events. The alerts may be transferred via various digital mediums as described herein and/or as otherwise known in the art.

A multitude of events may cause systems of the present disclosure to generate, receive, or propagate an alert. One purpose of the alerts or the present disclosure is to communicate to oncoming or approaching vehicles that a vehicle (either the one generating the alert or another one) may be in a disabled state, and may be creating a hazardous or otherwise anomalous road condition. Alerts may be generated automatically based on a number of occurrences. These include, but are not limited to, airbag deployment, ABS or traction control activation, and/or detection of a hazard by cameras or other on-board self-driving or driver assistance systems. Various sensors installed in or associated with a vehicle can be utilized to detect crashes and other types of hazards or alerting events. For example, crash sensors built into vehicle bodies or other components, microphones, interior-directed cameras or sensors, glass breakage sensors, and accelerometers can all be used alone or in combination to indicate that an alert should be generated. GPS data may be useful in this regard as well. For example, an indication that a non-off road vehicle has left a road surface might indicate that a crash or breakdown has occurred. Moreover, GPS and other location data can also indicate, for example, on which side of a roadway the hazard or other alert event has occurred. This can aid in increasing accuracy in delivering alerts to surrounding or oncoming vehicles, as well as minimizing the chance of alerting vehicles that are not likely to encounter the hazard or breakdown (e.g., on a divided highway, it may be most beneficial to alert only those vehicles on the same side as the hazard).

Crash sensor tolerances or an indication that a significant crash has occurred based on multiple crash sensor data points may be used by the alerting vehicle or a server receiving the alert data to determine how, when, and in what form to relay or deliver alerts to other vehicles or services. For example, detection of a low level or minor crash, possibly combined with GPS or other data indicating the alerting vehicle is moving normally or has reached a safe location off a road may result in such alert not being relayed to oncoming traffic (though the alert could still be delivered to other recipients such as the vehicle owner).

Systems of the present disclosure, in some embodiments, serve to notify other vehicles, drivers, or services, when a vehicle has become disabled on a roadway, whether there is an actual crash or injury or not. To that end, systems of the present disclosure may receive mechanical or operational data from other OEM vehicle computers. For example, an indication of a power system failure, a battery failure, a motor failure, a non-running engine, transmission failure, another major vehicle system has failure, overheating, flooding by water, one or more flat or critically low tires, and other events or data can generate an automatic alert. In some cases, such automated alerts may only be generated when GPS or another vehicle system indicates that the vehicle is no longer moving. In some embodiments, automatic alerts are generated only when the car is determined (e.g., by GPS or otherwise) to be on or within a predetermined distance of a roadway (in other words, an alert would not be generated for a disabled vehicle well off the road or in a parking lot, for example). In some cases, the system must determine that the vehicle has been placed in park or is travelling below a predetermined speed before an alert is automatically generated.

Where possible, systems of the present disclosure may also utilize an OEM's cloud service or tracking of vehicular location. Tire blowout and other tire-related events may be detected by vehicle tire pressure monitoring system (TPMS). Vehicle rollovers may be detected by crash sensors, gyroscopes, and/or accelerometers. Driveline failure may be detected by the vehicle's onboard computers, processors, and sensors. Fuel outages may be detected by a vehicle's onboard computers, processors, and sensors. Power system failures may be detected by a vehicle's onboard computers, processors, and sensors. An autonomous driving system-triggered stoppage of vehicle on or near the roadway may be detected. Other vehicle disabling events due to engine flood based on onboard computers, processors, and/or sensors may be detected. Each of these and more may result in a system of the present disclosure generating an alert.

Alerts may be generated by sources other than vehicles as well. For example, sensors may be placed to detect water levels, closure of roadway gates for toll roads and when roads are closed due to winter driving conditions, shifting or reconfiguration of lanes as occurs throughout the day in high traffic volume areas, railroad crossing gates, presence and/or speed or traffic, and other road conditions. Sensors providing such non-vehicle-generated alerts can pass alerts onward to an alert management center as discussed herein, whereupon such alerts may be transmitted in real time to vehicles in the area or that otherwise may have use or need of such alert.

In some embodiments, discrimination may be made as to whether an event or occurrence that is detected warrants an alert being generated. In some embodiments, all alerts are received by systems of the present disclosure, but discrimination is made as to whether alerts should be forwarded or delivered to other recipients (e.g., other vehicles). This discrimination may occur to reduce nuisance activations. Additionally, a significant threshold that may result in propagation of a received alert may be tailored to road conditions, weather, and other metrics. For example, a disabled vehicle well off the roadway when traffic is very slow may not be significant, while a disabled vehicle on the shoulder when traffic is both heavy and moving quickly may be significant.

Some embodiments of the present disclosure may generate an alert based on braking data gathered in real-time from multiple vehicles. For example, repeated instances of hard braking or avoidance maneuvers near a certain area within a given time frame can be taken for an indication that a hazard exists in the area that a vehicle sensor would not necessarily detect automatically. Even if it did not occur to any driver to manually send an alert (in systems or embodiments where this is an option), an alert management server receiving the relevant data might begin to send alerts to vehicles approaching the area.

Driving data gathered from vehicles regarding the manner in which they are being driven such as acceleration, speed, turning, braking and other parameters may be referred to as driving characteristic data. This data, whether from single vehicle or aggregated from multiple vehicles, may be utilized by systems of the present disclosure may be utilized to determine or infer that a hazard exists and/or its location. For example, hard braking and/or swerving behavior from a series of vehicles near a particular location may suggest a hazard exists at that location. Note that in this context, the driving characteristic data alone, however obtained, can be used to generate useful alerts even if few or none of the vehicles are equipped to send an alert per se.

Encountering a pedestrian on or dangerously near a roadway can generate an alert as well. The alert can arise from a properly equipped vehicle according to the present disclosure or it may be inferred as discussed above. In a case where a vehicle is quipped with a camera or other sensor capable of detecting a pedestrian, the fact that the alert was generated as a result of a pedestrian encounter can be included in any generated alerts.

In cases where multiple vehicles are generating alerts in close proximity, an alert management server may elevate the alert(s) being forwarded to oncoming traffic. Multiple vehicles generating an alert near an area could be suggestive of a multi-car pile-up, or a widespread issue (e.g., a fire or flood). In such case, an alert sent to oncoming traffic to exercise caution could become an alert suggesting to reroute or avoid the area. Input from emergency services received by an alert management server might also be used to elevate an alert forwarded to oncoming traffic (e.g., an indication from fire, EMS, police, etc. that an area should be avoided, or other data from fire, EMS, police, etc. from which the alert management server could infer this).

According to the present disclosure alerts may also be generated as a result of manual actions by the driver or other vehicle occupant. Such manual action may include, but is not limited to, activation of a switch (a dedicated or shared hardware switch or a screen-based soft switch).

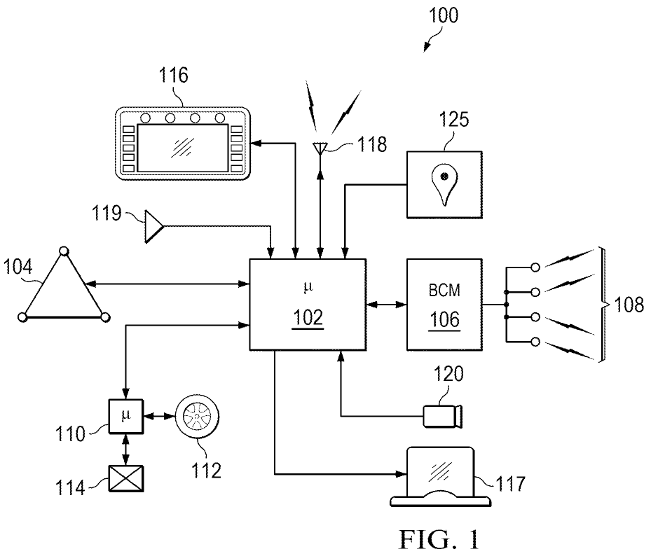

Referring now to FIG. 1, an exemplary system 100 according to the present disclosure is shown. FIG. 1 illustrates a simplified schematic diagram of a system 100 that can deploy high conspicuity visual indicators on a vehicle while also communicating the presence of such a deployment to other vehicles or systems. It should be understood that systems of the present disclosure can relay the presence or activation of traditional hazard flasher lights as well as high conspicuity visual indicators—it is not necessarily dependent on the specific light or hazard/warning system actually deployed. For purposes of the present disclosure, a high conspicuity visual indicator is a lamp or light visible on the exterior of a vehicle that is differentiable from headlamps, marker lights, parking lights, brake lights, signal lights, or traditional hazard flashers based on a variable or increased flash rate, a variable or increased contrast, a variable or increased brightness, an altered or variable color, and/or a combination of these.

Traditional hazard flashers and signal lights that have been installed on vehicles for decades generally have a flash rate of up to about two cycles per second, or 2 Hz. This was originally owing in part to the incandescent type lighting and analog circuitry that was state of the art when these systems were developed. This cycle rate has been carried into modern times until recently even where the vehicle lighting system is entirely controlled by a body control module (BCM) or other microcontroller. However, modern light emitting diodes (LEDs) as operated by microcontrollers, for example, are capable of a much wider range of operations in terms of cycle rate, intensity, and other parameters. For purposes of the present disclosure a hazard flasher is considered to be a lighting system operating according to a slow flash rate as would be supported by older incandescent bulbs and analog circuitry (e.g., around 2 Hz), even if the lighting system is actually LED and/or microcontroller based.

In some embodiments, the system 100 is based on a microprocessor 102. Control routines and programming may be encoded for execution on the microprocessor 102. Any suitable programming language compatible with the selected microprocessor 102 may be utilized. Programming by one of skill in the art may be implemented to achieve the functions described herein. In other embodiments “hard coded” silicone chips may be used that are not programmable or reprogrammable. In some embodiments, the microprocessor 102 may be a microcontroller or a system on a chip (SOC) and include its own memory, I/O controllers, A/D, D/A, etc. The microprocessor 102 (and the entire system 100) may be a standalone device installed as original equipment (e.g., at the time of a vehicle's manufacture), a dealer installed system, an aftermarket system installed by a suitable installer, or installed and setup in any other suitable manner. The system 100 may also be a subcomponent of a larger, more comprehensive system (such as a vehicle safety suite).

The microprocessor 102 may be a component or subcomponent of a BCM installed when a vehicle is constructed. In some cases, the functions of the microprocessor 102 may be encapsulated as a BCM that is a component of a vehicle when first manufactured. In such cases, BCM 106 and microprocessor 102 as shown in FIG. 1 would be combined a single component with all illustrated connections (and possibly more). Although a BCM, such as BCM 106, may be microprocessor/microcontroller based, application specific integrated circuits (ASICS), field programmable gate arrays (FPGAs) or other logic devices capable of implementing the required controls and routines may be utilized.

In some embodiments, the microprocessor 102 can be activated or signaled from a hazard switch 104. Hazard switch 104 may be a user accessible hazard light switch used to activate a hazard flasher or a high conspicuity lighting device. Activation of hazard flashers and/or a high conspicuity lighting system may also activate an alert. In other embodiments, the switch 104 is a dedicated or auxiliary switch used specifically to begin a vehicle-to-vehicle (or V2X) alert or signaling routine. In some embodiments, the switch 104 is a “soft switch” activated on a vehicle multi-purpose display or menu system 116. The switch 104 merely represents one way to activate the system 100 for various alerts and other functionality as described herein. In some embodiments, deployment or generation of an alert may be automatic instead of, or in addition to, use of the switch 104.

The display 116 may comprise an OEM component of a vehicle, an aftermarket device, or a device associated with a personal electronic device. For purposes of the present disclosure, a personal electronic device may include a phone, tablet, laptop, or any other device that is not necessarily an integral component with the vehicle but can nevertheless provide effective communication to the vehicle via wired or wireless interface. A personal electronic device may also include, without limitation, watches, rings, bracelets, glasses, and other wearable electronic devices.

Some personal electronic devices may be capable of obtaining biometric data from the driver or a passenger and using the same to trigger an alert. For example, a watch that detects a significant health event that is likely to incapacitate a driver, may trigger an alert. Whether or not an alert is triggered by such device, information gathered by a wearable device may be included in a data packet or digital alert for transmission according to systems and methods of the present disclosure. Such personal electronic devices may include watches, rings, bracelets, glasses, other wearable electronic devices, and/or any electronic device capable of gathering biometric data, health data, vital signs, and/or medical diagnostic data.

Voice activation provides an additional method by which the system 100 may be controlled. To that end a microphone 119 may be provided. The microphone 119 may be dedicated to the microprocessor 102 and/or may be a part of an existing or OEM system such as a hands-free navigation system, cell phone, or other personal electronic device communicating by Bluetooth or otherwise. Bluetooth® or other wireless microphones may be utilized as well (whether part of a phone or other device or a standalone microphone). Thus, the system 100 is useful and operable even if the driver or other user is not fully capable or is partially incapacitated. It is also known that certain vehicles today are capable by camera or other means to determine that a driver's focus has shifted from the appropriate task at hand (e.g., driving). Use of the microphone 119 also enables audio information (voice or other) to be included with an alert.

Cameras may also detect that the driver or another occupant is incapacitated. Such information can be used to trigger alerts. Thus, the system 100 may be activated to signal a hazardous condition even if the driver does not explicitly do so, and even if the associated vehicle has not yet deployed any other safety systems (e.g., traction control, airbags, etc.).

The microprocessor 102 may provide communication to an BCM 106 to activate one or more sets of lights 108 associated with a vehicle. Lights 108 may be activated in a flashing, strobing, or other communicative pattern. The lights 108 may comprise a set of OEM signal lamps. Signal lamps may include incandescent lamps or light emitting diodes (LEDs) with their faster recovery time and increased functionality. These may be used as hazard flashers, or as high conspicuity visual indicators based on control by the microprocessor 102 and/or BCM 106.

It should be understood that, in some embodiments, the microcontroller 102 comprises the BCM 106 itself. In other words, it may replace a previously-known BCM or it may comprise functionality that is added to an existing BCM via hardware or software. It should be understood that such additions and modifications include both OEM and after-market configurations.

A vehicle may also be placed into a hazard or distressed mode via an automated vehicle system represented here by microcontroller 110. The microcontroller 110 may be a dedicated device or may be an ABS computer or sensor monitoring one or more wheels 112 for slippage, skidding, etc. Microcontroller 110 may also be a traction control computer. The microcontroller 110 may be an airbag controller or sensor for controlling one or more airbags 114. The microcontroller 110 may also comprise an accelerometer. In some embodiments, the microcontroller 110 comprises the microprocessor 102 and/or the BCM 106. In further embodiments, one or more microcontrollers associated with a vehicle and/or systems of the present disclosure communicate via controller area network bus (CANBUS) or another network or protocol.

For purposes of the present disclosure, unless otherwise specified, any component or system exercising control over operation of any aspect of a vehicle may be considered an electronic control system. Electronic control systems may include, without limitation microcontroller 110, BCM 106, an ABS module, a traction control system, an airbag system, an engine or transmission controller, suspension controller, cruise control system, and automatic driving computers.

A forward-looking sensor (FLS) 120, such as a camera, radar, sonar, or other detection system, is a component that may gather information from the roadway or other location associated with a vehicle. The FLS 120 may be a component of a vehicle safety or automation system such as an automated cruise control system, a driver awareness system, or a self-driving system, for example. In some embodiments, the FLS 120 may feed information directly to the microprocessor 102 for analysis. However, the FLS 120 may also feed into the BCM 106 or to the associated vehicle safety system (e.g., self-drive) that then provides information to the microprocessor 102. Such provided information may include, for example, that the vehicle has left a lane or roadway, that a collision has occurred or is imminent, that an animal or obstacle is in the road, that another vehicle is in the road, or that a hazard is otherwise present. The ability to recognize such dangers is now known in the art. In various embodiments, the present disclosure provides systems and methods for communicating such hazards onward to outside systems and to vehicles and drivers that may not otherwise perceive such dangers.

In operation, if any of the hazards discussed above, or others, are indicated, or if skidding, vehicle traction control, ABS activation, air bag deployment, or any other safety related event is detected as having occurred by the microcontroller 110, this information may be relayed to microcontroller 102 and high conspicuity visual indicators (e.g., using lights 108) may be activated. It should also be understood loss of tire pressure, loss of engine coolant, transmission overheating, low or empty fuel level, and other events may also comprise triggers to place a vehicle into a distressed or hazard condition, resulting in high conspicuity visual indicators being activated. As illustrated, this may occur using lights 108. However, a separate beacon or auxiliary lights could also be used.

As a result of any kind of activation of a high conspicuity visual indicator, as performed by or otherwise indicated to the microprocessor 102, the system 100 may provide audible alerts to the driver that the system 100 has been activated for alerting or signaling and what mode it is in. A speaker 119 may be provided, or audible cues may be provided through the vehicle audio system or another system. Similarly, visual cues may be provided via the display screen 116, illumination of the switch 104, a heads-up display 117, or by other mechanisms. Various systems may be capable of multiple modes of high conspicuity visual indication as well as traditional hazard modes. Thus, the particular high conspicuity visual indicator or hazard mode deployed may be accessible and even alterable by the user (e.g., via voice command, display panel 116, switch 104 or other gear).

In addition to providing indication or feedback to the user or driver of the vehicle, the system 100 may communicate the hazardous, distressed, or emergency condition to other vehicles or receivers electronically. The onward communication of the distress/hazard/emergency condition may occur automatically. In some embodiments, the user can initiate such communication or can prevent its communication beyond the vehicle. For example, flashers (e.g., lights 108) may be activated for testing purposes or for visual effects not related to a true distress or emergency. It may be desirable to repress such communication to avoid false signals being propagated to other vehicles.

An antenna 118 may be provided for outbound communication. The antenna may be dedicated to use by the system 100 or may be a diversity antenna capable of more than one use. The antenna may be an OEM or after-market item. It should also be understood that more than one type of antenna may be employed. For example, as needed, the system 100 may include a Wi-Fi antenna, a cellular network antenna, a Bluetooth antenna, or others.

The microprocessor 102 may have access to GPS data for use in providing data about the vehicle in which it is installed, or for purposes of mapping a received signal to the location of the vehicle in which it is installed. A GPS unit 125 is shown in communication with the microprocessor 102 for purposes of illustration. The GPS unit 125 may be dedicated for use by the system 100, a separate vehicle subsystem or component of a subsystem, or could even represent GPS data or an “app” from a user's or occupant's personal electronic device.

Communication of the emergency event may be a simple indication to anyone with an appropriate receiver that a vehicle in the area is under distress (e.g., disabled, crashed, broken down, unexpected stopped, etc.). However, additional useful information may also be communicated. Information that may be communicated via the system 100 includes, but is not limited to, the vehicle system that signaled the emergency (ABS, traction, airbag, manual activation, etc.), location of the vehicle (e.g., via GPS), speed, mechanical state of the vehicle (operational or not), orientation of the vehicle (overturned or otherwise, and direction faced), deployment of airbags, and apparent state of the driver (engaging with controls or otherwise). In some embodiments, it may be possible to communicate the number of occupants of the vehicle, seat belt status, and further information that may be available to the microprocessor 102 via cameras or other sensors.

The system 100 when receiving alert data, such as location data, may calculate when the receiving vehicle is proceeding on an intercept course with the emergency condition or hazard (e.g., the disabled vehicle that generated the alert). The system 100 may discriminate and only notify operators of vehicles that are likely to encounter the vehicle that has signaled an emergency condition. This may minimize unnecessary warnings to vehicles nearby that are not on intercept courses or otherwise unlikely to encounter the hazard. In other embodiments, the system 100 associated with the vehicle generating the alert may have the ability to discriminate amongst which vehicles should receive its alerts (e.g., when appropriate data regarding other nearby vehicles is provided to it). In other embodiments, a remote server or cloud-based system receives all alerts from vehicles equipped with the system 100 or similar and determines which other similarly equipped vehicles receive which alert(s). In further embodiments, discrimination can occur at multiple points (e.g., the alert generating vehicle, the alert receiving vehicle, or the intermediate server, computer, or cloud-based system).

Notifications of received alerts to occupants of vehicles can comprise audio or visual indication systems that are either incorporated into the system 100, or alert notifications may be provided via an interface to a vehicle entertainment system or other system. If the receiving vehicle is equipped with a heads-up display, a visual indication may be projected. Using GPS information, the system 100 may also display the location of the vehicle in distress (i.e., generating the alert) on a GPS map display in the vehicle.

In some embodiments, the system 100 may be able to receive communications wirelessly (via antenna 118 or another antenna) that may be related to an emergency or hazard status of another vehicle. Thus, the microprocessor 102 may be communicatively coupled to both a transmitter and receiver. This allows the system 100 to inform the occupants that a vehicle nearby may be in a hazardous condition even if they cannot visually observe the vehicle (e.g., due to terrain, traffic, buildings, weather conditions, etc.). This may also allow the vehicle to be informed that an EMS, fire, police, etc. vehicle is on the roadway such that the driver can take precautions or prepare to stop or yield. The system 100 may also allow greater information to be provided to police or emergency personnel (e.g., number of occupants) than to other vehicles nearby identified only as normal civilian traffic. Of course, privacy concerns may have to be taken into account with any such system.

Within the present disclosure, various connections and relationships may be shown between components where communication of data and/or exchange of signal occurs. Such connection may be referred to as a “communicative coupling”. For example, the microprocessor 102 can be said to be communicatively coupled to the microcontroller 110, or to the display screen 116, or any other device with which it interacts. For purposes of the present disclosure, unless otherwise indicated, a communicative coupling can be based on any known reliable communication method or protocol. A communicative coupling may be as simple as a lead between components, or may be a more sophisticated industry standard connection such as universal serial bus (USB), or even a part of a controller area network bus (CANBUS). Communicative couplings may also comprise wireless protocols, or line of sight protocols based on infrared or other signals. In some embodiments, a communicative coupling for an alert or other data may occur via multiple communication systems (e.g., satellite and cellular, or via various intermediate servers), either simultaneously or sequentially.

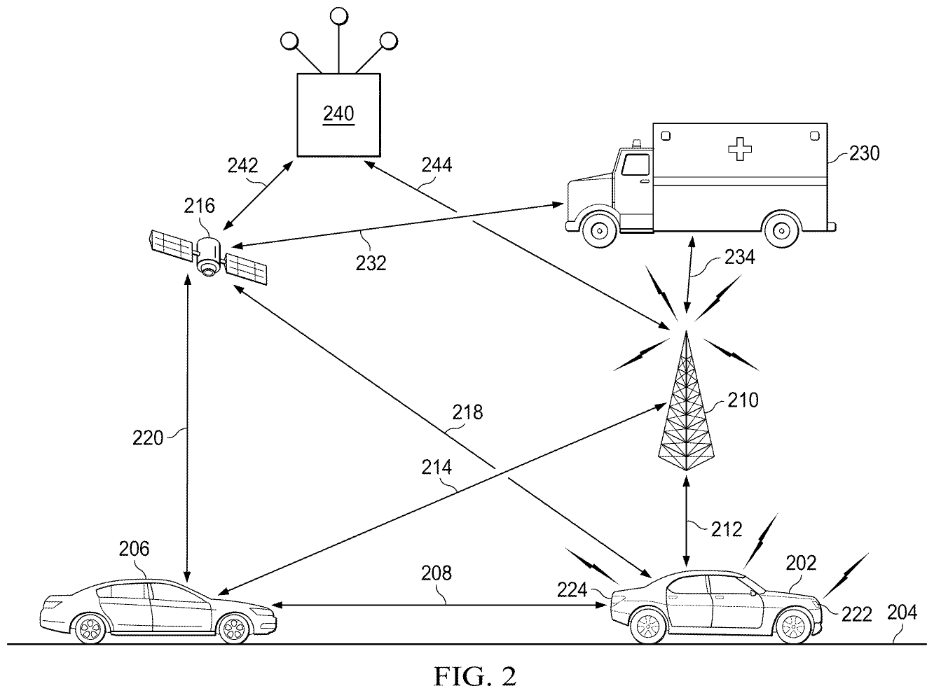

With reference now to FIG. 2, various examples of mechanisms of communication between vehicles utilizing a system such as those of the present disclosure are shown. Here, a vehicle 202 is shown a distance apart on a roadway 204 from a second vehicle 206. It should be understood that the vehicles may be much further away than shown and that terrain, obstacles, and other cars may interpose the two exemplary vehicles shown. The vehicles 202, 206 are also presumed to be equipped with a communicating hazard or safety system such as the system 100 or similar.

In the present example, vehicle 202 has encountered a hazard, breakdown, collision, or other event that has caused the vehicle to be placed in a state of hazard, emergency, or distress. A high conspicuity visual indicator may be deployed by the vehicle 202. In this case the high conspicuity visual indicator comprises front signal lights 222 and rear signal lights 224, and both may be strobing at a high rate, and/or providing a directional strobe (e.g., right to left). This may occur manually by action of the driver or another occupant, or automatically by one or more automatic vehicle systems. In order to provide advance warning to other drivers, or to summon emergency services, or for other reasons, the hazard state may be communicated wirelessly.

In the example shown, the vehicle 202 communicates the hazard condition to vehicle 206 thus allowing vehicle 206, either automatically or because of control by its driver, to be prepared for an emergency ahead that may not be visible from the car's 206 location. In some embodiments, radio communication 208 may occur directly, vehicle-to-vehicle. The signal or alert communicated in this direct fashion could be a digital or analog signal occurring on a dedicated radio frequency set aside for such purpose. However, it may also occur via a network system having a built-out infrastructure such as, but not limited to, a mobile phone network or a satellite-based network.

It should be understood that more than one car may receive the alert or indication of the emergency from vehicle 202. For example, more than one vehicle may receive a locally broadcast signal. Additionally, in some embodiments, the vehicle 206 may automatically further relay the received information in a daisy-chain like fashion. In some embodiments, there may be a limit to the number of times or the distance that the emergency indication or hazard may be relayed. For example, there may be little or no benefit to relaying a message to a vehicle several away that may not encounter the hazard at all, or not within any reasonable time frame. The distance a receiving vehicle is from an originally transmitting vehicle may be based on available GPS data, cell tower data, or other information available to the microprocessor 102.

It is contemplated that the direct, wireless, vehicle-to-vehicle communication by systems of the present disclosure may take place by any known wireless radiofrequency protocol. It should also be understood that vehicle-to-vehicle communication may take place via visual light signaling (e.g., vehicle 206 monitoring for high frequency strobing of lights on vehicle 202, such as by camera 120), via infrared (with IR transceivers integrated with the associated vehicles) or via other light-based communication methods.

As illustrated, the vehicle 202 communicate the present hazard condition to a wireless phone or data network (e.g., cellular) represented here by network tower 210 as shown by cellular communication link 212. The network tower 210 may comprise a phone and data network such as a 3G/4G/5G or other network. Systems and methods of the present disclosure are intended for operation with any known network unless otherwise indicated. The network 210 may communicate the emergency or hazard to other vehicles in the area as shown by cellular communication link 214. Here again, not every vehicle in the area is necessarily impacted by the particular hazard being encountered by vehicle 202. The systems on-board the alerted vehicles (e.g., system 100) may discriminate between hazards affecting or not affecting the alerted vehicle based on location and type of emergency (if provided). For example, a hazard on an adjacent street would not necessarily cause an alarm or any other action on a vehicle receiving indication of the hazard from network 210.

In another embodiment, the presence of the hazard may be relayed to relevant vehicles and other devices through an alert via a satellite network 216. In such case, the vehicle 202 may convey the emergency or hazard alert, including relevant data, to satellite network 216 via satellite communication link 218. Such information or alert may be relayed then to vehicle 206 via satellite communication link 220 or other vehicles by the network 216, possibly using other satellite links. It should be understood that the satellite network 215 may provide more than a single satellite. Systems and methods of the present disclosure are not intended to be limited to any particular satellite system implementation.

In addition to other vehicles, such as vehicle 206, hazards and alerts may be communicated to emergency services 230. This may occur, for example via a satellite communication link 232, a cellular connection 234, or another communication link. Emergency services may include, but are not limited to, fire, police, ambulance, and road-side assistance services. If the information provided by the vehicle signaling the hazard is sufficiently detailed, time may be saved by dispatching the most relevant service to the distressed vehicle 202. For example, if the hazard or distress alert is only the result of a mechanical breakdown, roadside assistance and perhaps police may be signaled, but EMS or fire might not. Similarly, alerts may be generated automatically or manually by emergency services 230, which can then be passed to vehicles such as vehicles 202, 206 or others. An emergency services vehicle equipped with a system 100 or similar according to the present disclosure, may generate alerts based on being at the scene of a disabled vehicle, medical emergency, or other hazard as well as by experiencing mechanical difficulty or detecting a hazard similar to a passenger vehicle as described herein. In some cases, an emergency vehicle equipped with a system 100 or similar according to the present disclosure may have the ability to manually generate an alert.

A sensor network 240 represents an alert source other than a vehicle. The sensor network 240 could comprise, for example, a network of sensors such as water, traffic, gate, roadway and other sensors as known in the art. The network 240 may comprise a computer network, a microcontroller, or other computing device determining when the associated sensors have detected a hazard or other event that should result in an alert. Location information may be provided with the alert as well. A satellite communications link 242, a cellular link 244, or other communications links may be used to allow alerts generated from sensors and/or the sensor network 240 to be propagated. It should also be understood that radio communication 208, cellular communication link 212, cellular communication link 214, satellite communication link 218, and satellite communication link 220 are further instances of communicative couplings. A communicative coupling is not necessary a physical link or coupling unless specified.

As with vehicle-to-vehicle signaling, the vehicle system (e.g., system 100), the sensor network 240, and or another server or cloud computing system may determine which particular vehicles should receive an alert from the sensor network 240. It should also be understood that more than one non-vehicle sensor network may be utilized as various non-vehicle sensor networks may be implemented based on location, type of structure or event monitored, ownership of networks, etc.

An alert, an alert signal, or an alert communication can take any number of forms. In one embodiment, an alert is simply a signal that a hazardous communication exists in the area. For example, a broadcast on a specific frequency may occur, or a digital signal delivered over any communicative coupling. However, increasing the information contained in an alert or alert signal, even with a small amount of data that requires little bandwidth or time to communication, can greatly enhance the utility of an alert. Additionally, the contents of an alert may depend on the type of alert, and/or whether it is inbound (to a vehicle) or outbound (from a vehicle).

Referring now to FIG. 7, an exemplary diagram of an Outbound Alert is shown. The format shown is only an example, as one of skill in the art will appreciate that information can be formatted and transmitted in a wide variety of ways. The Outbound Alert of FIG. 7 is an example of an alert that might be generated from a passenger vehicle manually, automatically, or have a combination of automatic and manual elements. For example, an Incident ID may be automatically generated or assigned. It may be generated by the vehicle alerting system (e.g., system 100) or by a communicatively coupled alert management system. An incident ID may be useful for archival purposes but also to allow further alerts to be generated based on the same incident. For example, an initial incident such as a stalled vehicle may cause an alert to be generated. However, if airbags later deploy (suggesting the vehicle has been struck by another car) a subsequent alert may generated under the same incident ID. A vehicle ID may be transmitted as well.

A Location field may include GPS coordinates or other location information. Vehicle speed may be provided as well. Although this may be zero fairly often, it is not necessary so. For example, an alert may be generated based on ABS or airbag deployment. High speed processors and networks may allow an alert to be generated and transmitted before the vehicle comes to rest or if it continues to move. Alerts may also be useful in the case of a vehicle that continues to move following the alert for safety or other reasons. For example, a vehicle with a flat tire (generating an alert) on a busy freeway may elect to drive slowly to an offramp.

Orientation may refer to the orientation of the vehicle itself. The direction a vehicle is facing may be based on compass readings, accelerometer data, and the like. This can indicate severity of an accident or nature of a hazard. Similarly, a vehicle overturn may be indicated. Engine state may refer to whether the vehicle engine is operating, or operable at all. Similar statuses may be reported for electric vehicles. Airbag may refer to whether an airbag was activated. Passenger state may provide information relating to occupant health. Some vehicles are able to determine whether it is likely a driver or passenger is conscious for example. Additionally, where a wearable device or other personal electronic device has reported passenger or driver health data to the system, this may be transmitted with the alert if relevant.

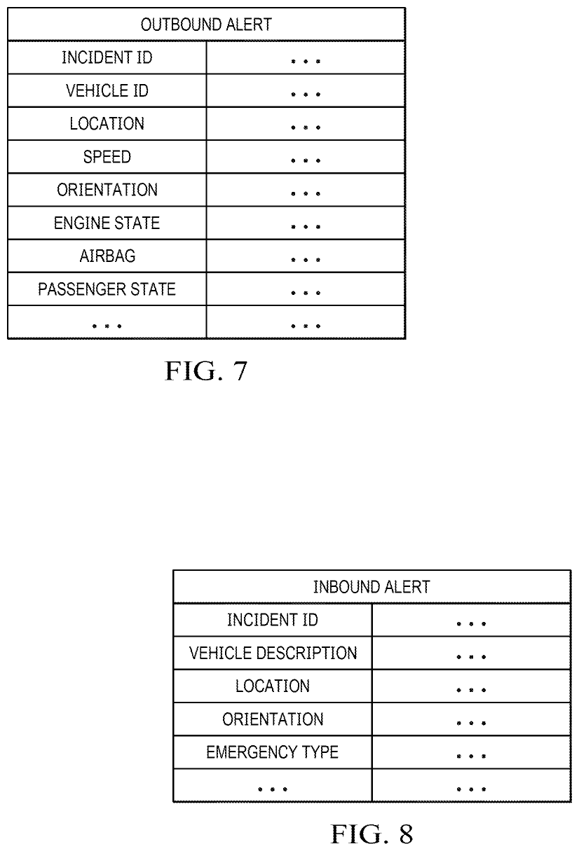

Referring now to FIG. 8, an exemplary diagram of an Inbound Alert is shown. The format shown is only for example, as one of skill in the art will appreciate that information can be formatted and transmitted in a wide variety of ways. The Inbound Alert of FIG. 8 is an example of an alert that might be sent to a passenger vehicle having a system similar to the system 100 by an alert management system via satellite, cellular, or other communication channel. The Inbound Alert may be used as the basis for the system 100 to generate warning for the driver or a passenger, or take any number of actions such as those disclosed herein.

The Inbound Alert such as shown in FIG. 8 may provide a Vehicle Description of the vehicle which originally generated the alert (if applicable). For example, the Vehicle Description may simply recite “Blue Sedan” or “White Truck.” It may also contain more detailed information such as license plate numbers of other public identifiers. This information may be related to drivers/passenger as by display screen 116, for example. A Location field may contain GPS in formation of the vehicle generating the alert, which enables the position on a map of the distressed or alerting vehicle to be displayed on display screen 116, to be used for route guidance, or for other uses by the system 100. Orientation may be another useful field to enable the system 100 to inform the user that the distressed vehicle is facing the wrong way in traffic, overturned, etc.

An Emergency Type field may be useful to inform a user (a user can be a driver or a passenger) of the system 100 what kind of emergency is being reported. For example, a stalled vehicle, a flat tire, an overturned vehicle, a medical emergency, or a collision can all be indicated in such field. Additionally, such field may be changed, and the alert retransmitted as circumstances change. For example, a stalled vehicle may become a collision report. Resending the Alert with the appropriate fields updated but using the same Incident ID can allow the system 100 to update or notify the user accordingly. Other fields may be updated as well as circumstance warrant.

The data fields of the Outbound Alert of Figure may be formatted a number of ways, as is known to the art. The fields may comprise simple ASCII characters, hexadecimal values, or other kinds of data. In some instances, the alert is encrypted according to known methodologies. Again, inbound or outbound messages, alerts, or other communications may be formatted differently with different data and fields than shown in the examples of FIGS. 7-8.

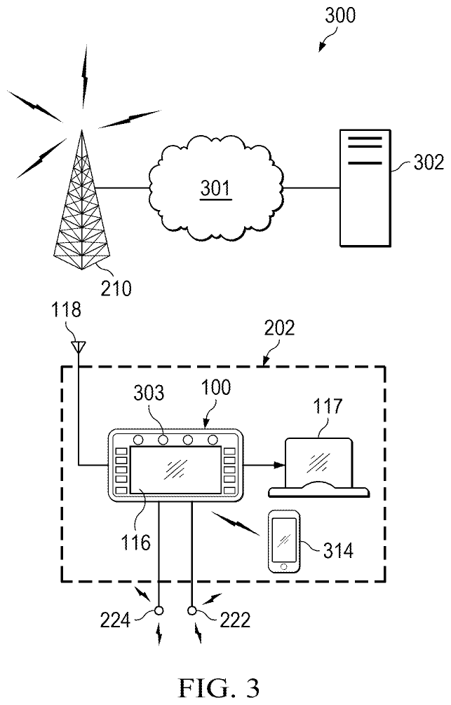

Referring now back to FIG. 3, a communication link diagram of another embodiment of an emergency communication system 300 according to aspects of the present disclosure is shown. The system 300 shares the vehicle installed components with the system 100 (but not all components are shown for purposes of clarity). Here, a particular vehicle 202 is shown as a logical boundary line. The high conspicuity visual indicators 222, 224 are shown outside the boundary of the vehicle 202 to denote that they are visible outside the vehicle 202 (e.g., front and rear). The internal components of the system 100 are illustrated within the vehicle 202 with display screen 116 and option switchgear 303 being visible. If a heads-up display 117 is provided as original equipment or an aftermarket add-on, it may be communicatively coupled to other components of system 100 (such as the microcontroller 102) for receiving and displaying warnings, messages, or other information. The antenna 118 is also shown external to vehicle 202 but it may actually be within the confines of the vehicle so long as it is able to establish a communication link with network 210. Only a single vehicle 202 is shown schematically for clarity, but it should be understood that multiple vehicles may be equipped with the system 100 or similar such that they are able to participate in issuing and receiving warnings as described herein.

The network 210 may send and receive communications to and from the vehicle 202 and other vehicles as previously described. Here, however, the network 210 sends data via the internet 301, using TCP/IP, HTTPS, and/or another suitable protocol(s). Data may be encrypted or otherwise protected as is known in the art. Data from the vehicle 202 is ultimately provided to an alert management system 302. The alert management system 302 may comprise a computer, a server, or another computing platform. In some embodiments, the alert management system 302 comprises a distributed system such as a cloud computer or server or multiple cloud computers or servers in communication with one another. Redundancies, such as multiple redundant servers capable of acting as the alert management system 302, may be employed to ensure continuous availability of the alert management system 302. It should be understood that the alert management system 302 may be any device capable of fulfilling the role of processing, analyzing, prioritizing, and distributing indications of hazard conditions and location data using software methods as are known in the art

The alert management system 302 may track vehicles based upon GPS location or other data. Thus, the alert management system 302 may then discriminate as to which other vehicles any received hazard or emergency condition notification should be relayed to. The alert management system 302 may also be connected to request EMS or other services automatically. GPS and other known data can be provided by the alert management system 302 to the relevant services aid in faster response times.

In some embodiments, the alert management system 302 receives an alert, including data about the alert, and then determines based on the data what type of alert has been received and how, when, and where to forward the alert. For example, an alert received from the vehicle 202 or elsewhere may simply reflect an alert status, and then a set of data that caused the alert. For example, if the data with or contained in the alert is an airbag deployment indicator, or crash sensor data, the alert management system 302 may determine that a crash has occurred and will propagate alerts to other vehicles and services (e.g., EMS) accordingly. On the other hand, if the alert data is based on engine or driveline failure, a different kind of alert may be sent to nearby traffic and services (e.g., roadside assist). Inbound and outbound alert formats are discussed in further detail below. In addition to alerting other vehicles and services when an alert is received from a vehicle, the alert management system may also send data elsewhere for logging or archiving, in addition to performing its own logging or archiving. Entities or recipients other than vehicles and services may receive alert notifications as well. For example, a car owner, a parent/guardian, or a commercial vehicle dispatch office or the like may receive a text, email, voice alert or other type of alert based on being associated with a vehicle such as vehicle 202 that generates an alert.

Also shown in FIG. 3 is an example of a personal electronic device, a phone 314, in communication with the system 100. Communications can occur via Bluetooth or another wireless protocol, or via a tethered/wired connection. In some cases, the phone 314 may provide interaction with the system 100 possibly providing occupant/user data and/or GPS information. The system 100 may be partially or completely controllable via the phone 100 via an app or another suitable interface. The system 100 may also be operable to interface with a phone 314 via well-known protocols such as Apple CarPlay®, Android Auto®, or others.

In some embodiments, the system 100 may comprise an application running locally on a vehicle infotainment system or other vehicle system capable of executing applications and/or programming (whether after market, third party, or OEM). In some cases the system 100 may include a program or programs running remotely on a remote computing platform or a cloud computing system that is in periodic or continuous communication with a display unit or infotainment system of the vehicle to be used for one way or two way communication with the driver or use of the system (e.g., the vehicle may act as a “dumb terminal” for all or part of the system 100).

In some embodiments, systems of the present disclosure are agnostic as to whether communications, messages, and/or alerts are carried by 2G/3G/4G/5G cellular, satellite, dedicated short range communications (DSRC), disparate intermediary systems, or any other suitable future communication technologies. Communications links, signaling, and/or messaging may occur as a direct connection between a vehicle's telematics system and a cloud, which then determines where to route information based on hazard condition and location. As an example, consider that a “Brand X” vehicle may send information directly to a cloud system according to the present disclosure, bypassing the OEM “Brand X” cloud. A direct communication connection may be made between an aftermarket-installed modem and a cloud which determines where to route information based on hazard condition and location. As an example, an aftermarket transponder according to the present disclosure may send data directly to a cloud system according to the present disclosure.

In some embodiments, connections between a vehicle's telematics system and an OEM cloud may be made. The OEM cloud may then send the received information to another cloud system, which determines where to route information based on hazard condition and location. For example, a vehicle communicates a hazard event to an OEM cloud, which then integrates with a cloud system of the present disclosure to pass along data. Connections may also be established between a vehicle's telematics system and an intermediary cloud, which then sends the information to a cloud which determines where to route information based on hazard condition and location. For example, a delivery vehicle communicates directly (built-in modem, not a bolt-on transponder) to the company's fleet management cloud, which then integrates with a cloud system of the present disclosure, to pass along data. Connections may be established between an aftermarket-installed modem and an intermediary cloud, which then sends the information to a cloud which determines where to route information based on hazard condition and location. For example, a commercial truck communicates to any on-board communication unit which sends data to the company fleet management cloud, which then integrates with a cloud system of the present disclosure to pass along data.

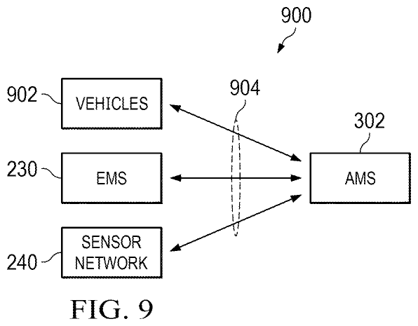

Referring now to FIG. 9 an exemplary diagram of various communication links 900 between systems of the present disclosure is shown. An alert management system 302 may aggregate data or outbound alerts to determine how to populate fields (e.g., within transmitted inbound alerts) before alert delivery. For example, a number of collision alerts in an area over a short time frame may indicate a pile up, thereby altering which vehicle in an area receives the alert, as well as whether to report the alerts as a collision, pile up, traffic jam, etc. To this end, the alert management system 302 may have a communicative coupling with one or more vehicles 902, EMS 230, and one or more sensors or sensor networks 240. These communicative couplings 904 can be one-way or two-way as needed. Additionally, the communicative couplings 904 can occur via any suitable wire, wireless, or optical system. This includes, without limitation, cellular, satellite, frequency modulation, microwave or any other suitable electromagnetic communication mechanism, and well as known wireline or optical communication mechanisms.

As shown, the system of FIG. 9 has a hub and spoke topology. This may allow data and alerts to be aggregated in one system 302 in real time and may have benefits for archiving and aggregating. However, systems of the present disclosure may be implemented in a peer-to-peer fashion or based on any suitably topology. As discussed above, redundancies may be implemented on a computer/server/cloud level as well as on a network level. In some embodiments, systems according to the present disclosure may default to a first type of connection (e.g., cellular) but then immediately move to a backup system if/when needed (e.g., satellite).

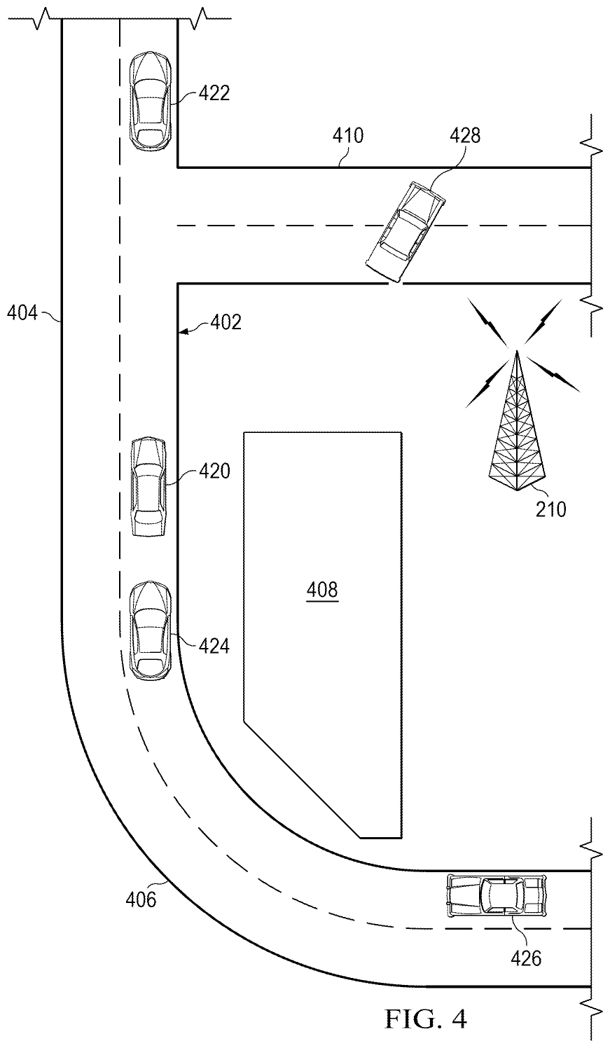

Referring now back to FIG. 4, a diagram 400 illustrating potential relationships between driving and disabled vehicles on a road network is shown. Diagram 400 is intended to illustrate at least some of the functionality of devices and systems according to the present disclosure as deployed in realistic scenarios. A roadway 402 is shown having a straight section 404 joining a curved section 406. Where the straight section 404 joins the curved section 406 a clear view of the roadway 402 is blocked by a building 408 (but this could be any other obstacle including trees, terrain, guardrails, or even limited visibility due to weather conditions). A side road 410 is also shown joining the roadway 402 on the straight section 404. Various vehicles 420, 422, 424, 426 are shown at various locations for illustrative purposes.

In a basic example, if vehicle 422 has encountered a hazardous condition (such as, but not limited to, any of the examples provided above) and it is properly equipped (“properly equipped”) meaning, in this context, outfitted with a system 100 or similar according to the present disclosure), it may deploy a high conspicuity visual indicator (manually or automatically) resulting in a wireless alert being sent indicating the hazard. Presuming vehicle 424 is properly equipped, it may receive the alert (directly or from the network 210) and thus be alerted, perhaps long before the hazard is perceived by the driver. If the vehicle 424 has cruise control activated, it may be cancelled, braking may be activated, or any number of preliminary measures based on automated vehicle control systems.

In some embodiments, driver assistance features are automatically cancelled upon receipt of an inbound safety alert. In some embodiments, receipt of inbound alerts may trigger, automatic activation of features such as hazard lights (standard or high conspicuity or strobing). According to some embodiments, self-driving or navigation systems re-route upon receipt of an inbound safety alert to avoid the location of the vehicle that issued the original outbound safety alert, or to avoid related or unrelated traffic congestion.

If the vehicle 424 is also properly equipped, the hazard indication may be communicated to it as well (from vehicle 420 or network 210). Thus, even though vehicle 424 may have limited visibility down the road because of vehicle 420, and may otherwise have no indication of any hazard apart from slowing or evasion of vehicle 420, it can now be alerted and the driver or an auto drive system can take appropriate precautions. Any automatic steps taken, or the level of warning provided to a human driver (e.g., louder alarms, visible flashing lights, etc.), can be increased based on the proximity of either vehicle 420, 424 to the disabled or hazard-stricken vehicle 422 depending on proximity, speed, road condition, or other factors.

In some situations, a vehicle receiving an alert of hazard condition from a nearby vehicle may automatically deploy its own high conspicuity visual indicators. For example, once vehicles 420 or 424 are near enough to the hazard-stricken vehicle 422 not to provide a visual signal where it is not needed, they may deploy their own high conspicuity visual indicators in the interest of providing warning to vehicles that are not equipped with systems according to the present disclosure.

In another example, if vehicle 420 were disabled in the roadway, vehicle 424 may deploy its own high conspicuity visual indicators upon encountering the vehicle 420 and automatically send a signal indicative of a hazard condition to network 210 and/or via local broadcast since it is in a highly dangerous situation owning the limited view around building 408. Such action may be taken by a system 100, for example, deployed in vehicle 424, even if the driver does not react. The microprocessor 102 may be informed based on GPS data, camera data, or other data that the vehicle 424 has become stopped in a roadway and it is not the result of a traffic jam or other relatively benign condition. Approaching vehicle 426 may therefore be alerted based on its own system (e.g., system 100) and if it is not so equipped, the driver will at least have an improved chance at reacting in a timely and appropriate manner based on the increased conspicuity of vehicle 424.

In another example, vehicle 428 is wrecked on side street 410 and occupies two lanes of traffic. If the vehicle 428 is properly equipped, (e.g., with a system such as 100) it may automatically deploy high conspicuity visual indicators and a communication of its situation and GPS location locally, by direct broadcast, and/or via network 210. Although vehicle 420 may be passing very near the disabled vehicle 428, its own high conspicuity systems may not deploy as its own microprocessor 102 can compute that, based on GPS data, vehicle 420 will not necessarily encounter vehicle 428 at all. Thus, the signal corresponding to disabled vehicle 428 may not be improperly propagated potentially causing slowdowns or pile on collisions from vehicles 424, 426.

It should be understood that these examples are illustrative only, and that systems and methods of the present disclosure may have many other modes of operation and many other capabilities. It should also be understood that, in addition to direct, vehicle-to-vehicle communication and communication via network 210, that the illustrated vehicles may communicate via satellite and/or a server-based system (e.g., 300) or a combination of these.

Alerts generated and forwarded from vehicle-to-vehicle, vehicle to cloud, or cloud to vehicle and to any other system may provide details regarding the alert-generating vehicle's situation and situational awareness that may be of use or benefit to responders and other roadway stakeholders. A communication comprising an alert may include a hazard condition, vehicular location, and year, make, model, color, owner and passenger information, etc. to roadside assistance network provider via data packet for purposes of communicating condition and accelerating response. As an example, data transfer of the foregoing via an alert can be provided to roadside assistance service. As an example, such data or alert may be transferred to a 911 call center. It should be understood that the foregoing examples represent actual data transfer and not simply an automated call or automated connection to a call center, which may be much more limited in utility.

Additionally, an alert may comprise a communication including the hazard condition, vehicular location, and year, make, model, color, owner and passenger information, etc. sent to subscriber's elected emergency contact list. As an example, a text or automated phone call to an owner of vehicle or parents/guardians. Another example alert may also comprise includes sending of such data to a fleet operator, fleet management system, command center, a text/call to fleet supervisor or company owner, etc.

In some embodiments, hazard condition data such as the above or other may be communicated to emergency broadcasting service as part of an alert. Further distribution of such data may be geofenced to only be distributed to nearby roadway users. In some cases, an alert communication may include a hazard condition, vehicular location, and/or year, make, model, color, owner and passenger information, etc. sent to traffic management systems via data packet for purposes of communicating situational awareness. For example, in a case of a multi-car pile-up (indicated directly or inferred based on data from multiple vehicles), an alert communication may indicate that traffic is likely heavy from road blockage ahead. Traffic management systems may use this information to turn the navigation screen depiction on nearby vehicles of the route ahead yellow or red or provide a warning in some other manner. This is primarily done today by traffic cameras sensing heavy traffic. However, systems and methods of the present disclosure improve alerting and render it more accurate.

In some cases, road conditions may exist that are not necessarily related to any particular vehicle, but nevertheless may present a hazard that can be mitigated by effective communication utilizing systems and methods of the present disclosure. When such events are detected or manually provided to systems of the present disclosure, relevant alerts can be generated and propagated through the system accordingly. Manual provision of events can be performed, in some embodiments, by drivers, passengers, or other users of the system. In some embodiments, EMS, police, fire departments, roadside assistance services, and others can provide manual alerts.

Events that may be reported that do not necessarily correspond to a specific vehicle alert include presence of a pedestrian on the roadway or in an otherwise unsafe location. Another event may include automatic emergency braking (AEB) and other active countermeasures. Systems of the present disclosure may aggregate alerts and data from alerts when there are multiple vehicles slamming on brakes in close proximity to one another and alert oncoming drivers of a potential accident scene or suddenly stopped traffic forming ahead. When multiple vehicles are stopped ahead (even if not caused by a crash), alerts can be sent to oncoming drivers.

Overly hot cars can generate alerts as well. An alert may be distributed by a cloud system of the present disclosure to roadside assistance, emergency responders, vehicle's owner, parents of vehicle's owner, etc. Such alerts may be useful in preventing injuries to children or other occupants left in an unattended car, for example.

Alerts related to high water on a roadway can also be propagated. Drivers may not realize how high water is and drive into deep water. Vehicles can become stuck in high water and swept away, sometimes resulting in injuries or fatalities. Transponders may be placed on the water level gauges (e.g., as part of a sensor network 240) and transmit to a system according to the present disclosure, which may then alert oncoming drivers that the road ahead is impassable.

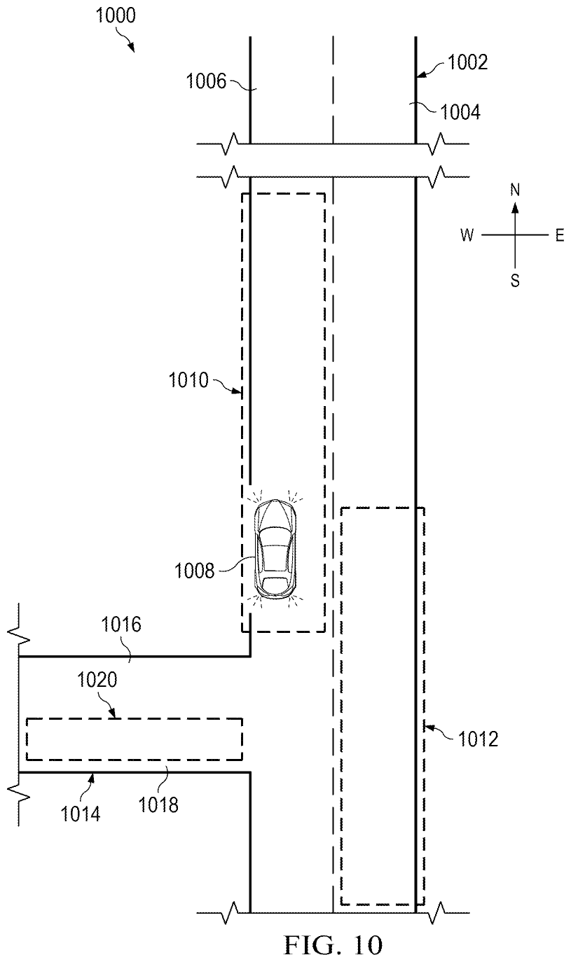

Referring now to FIG. 10, a diagram of a geofenced alert distribution arrangement 1000 according to aspects of the present disclosure is shown. FIG. 10 is intended to represent another realistic scenario for application of a digital alerting system 100 or similar according to the present disclosure, possibly to include an alert management system 302 or similar according to the present disclosure, and any intervening and necessary communication links or communicative couplings. The scenario of FIG. 10 shows a roadway 1002 having a north bound side 1004 (which may include one or more lanes) and a southbound side 1006 (which may include one or more lanes). As an example, a disabled vehicle 1008 has come to a stop on the southbound side 1006. The vehicle 1008, either automatically or manually, has deployed a digital alerting system 100 to transmit an alert (detailed or otherwise) to an alert management system 302.

The alert management system 302 may begin tracking all vehicles to which it is connected, which are known to be within an approach area 1010 on the southbound side 1006. In some embodiments the alert management system 302 continually or intermittently tracks vehicle equipped with an alerting system 100 or similar. In some embodiments, once an alert is received by an alert management system 302, it may send a position request communication, that is not necessarily an alert, to properly equipped vehicles (e.g., containing a system 100 or similar) known or estimated to be in the general area of the alert. Such determination may be made based on prior communications, GPS data, cell phone data, satellite data, or other. Once position information for vehicles in the general area is more precisely known it may be determined which vehicles are in the approach area 1010, for example, and should receive the actual alert message. Automated position gathering from properly equipped vehicles prior to issuance or forwarding of a received alert to the same may prevent unnecessary or nuisance alerts.

A second approach area 1012 may be defined on the northbound side 1004 of the roadway 1002. Note this area extends from approximately the location of the disabled vehicle 1008 in a southward direction, while the area 1010 extends from approximately the position of the vehicle 1010 in s northward direction. If vehicles within these areas 1010, 1012 only are alerted, then vehicles likely to be approaching the disabled vehicle 1008 are alerted while those not likely to be approaching the vehicle 1008 are not, even if they are closer measured by distance alone. It should also be understood that, in this and other embodiments, an approach time in addition to or instead of distance can be used to determine which vehicles should receive an alert. The time may be based on vehicle speed and distance from the hazard, for example. It should also be understood that distances may be determined based on point to point (e.g., “as the crow flies”) or can also be a based on a pathway or anticipated pathway using available roads and/or other drivable surfaces (e.g., a map distance).

Depending on the type of alert from vehicle 1008 approach area 1012 may not be alerted (for example, if the roadway 1002 is a divided roadway, or if the alert is only for a relatively minor hazard such as a flat tire when the vehicle 1008 is on the shoulder or even off the roadway 1002).

A side road 1014 is also shown joining roadway 1002 from the west. Vehicles travelling on westbound lane 1016 on this road 1016 may not have need to receive an alert regarding disabled vehicle 1008, but those travelling in an eastbound lane 1018 may benefit from an alert. This an approach zone 1020 may be defined in the eastbound lane 1018 as it approaches roadway 1002. Vehicles within this approach zone 1020 may receive alerts related to the disabled vehicle 1008.

A vehicle approaching the roadway 1002 from side road 1016 may not actually be on course to encounter the vehicle 1008 or a hazard near this area. For example, a vehicle may be approaching the roadway 1002 to make a right turn, which would be heading away from the vehicle 1008. Therefore, in some embodiments, the approach zone 1020 may be defined only to cover the leftmost lane or lanes of those heading east (and therefore lanes most likely to contain vehicles turning left or north from this position). In other embodiments, the approach zone 1020 is still considered to cover all lanes, but systems of the present disclosure may track vehicles' positions within the approach zone 1020 and only alert those in the left lane(s). In further embodiments, all vehicles in the approach zone 1020 are alerted such that they are all given the option to turn right and avoid the disabled vehicle 1008 or other hazard, or to proceed left at the intersection, with the foreknowledge that additional caution with potential slowdowns are expected when turning this direction.

In addition to GPS data relayed to an alert management system 302 by any vehicle(s) in the approach zone 1020 (or another zone or area), a system 100 or similar may also provide other sensor data including camera data, steering wheel angle, signal light activation, and other data that could indicate the intention of the driver or planned direction of a vehicle approaching a junction or intersection. This information can be further used to discriminate when to send an alert. For example, if a properly equipped vehicle approaches the roadway 1002 in approach zone 1020, but is indicating right, an alert may not be sent, or, if received, the system 100 may not notify the driver. On the other hand, being in approach zone 1020 with a left signal or indicator on, may cause an alert to be sent or a received alert to be brought to the attention of the driver. In further embodiments, being in approach zone 1020 (or similar location where turn direction can result in encountering or avoiding a hazard) may result in an alert being brought to the attention of the driver in a reduced or less intrusive manner (e.g., illumination of a light), but being in the zone 1020 combined with a turn signal or other data tending to indicate the vehicle is going to move toward the hazard may result in an elevated notification (e.g., a flashing light or an audible alert).

It will be appreciated by those of skill in the art that the scenarios described herein with respect to FIG. 10 are exemplary only. Many other road configurations, scenarios, and use cases can be covered utilizing the systems and methods of the present disclosure. The hazard represented by vehicle 1008 may be a hazard owing to multiple vehicles, traffic jams, road blockages, closures, railway crossing, bridges, etc.

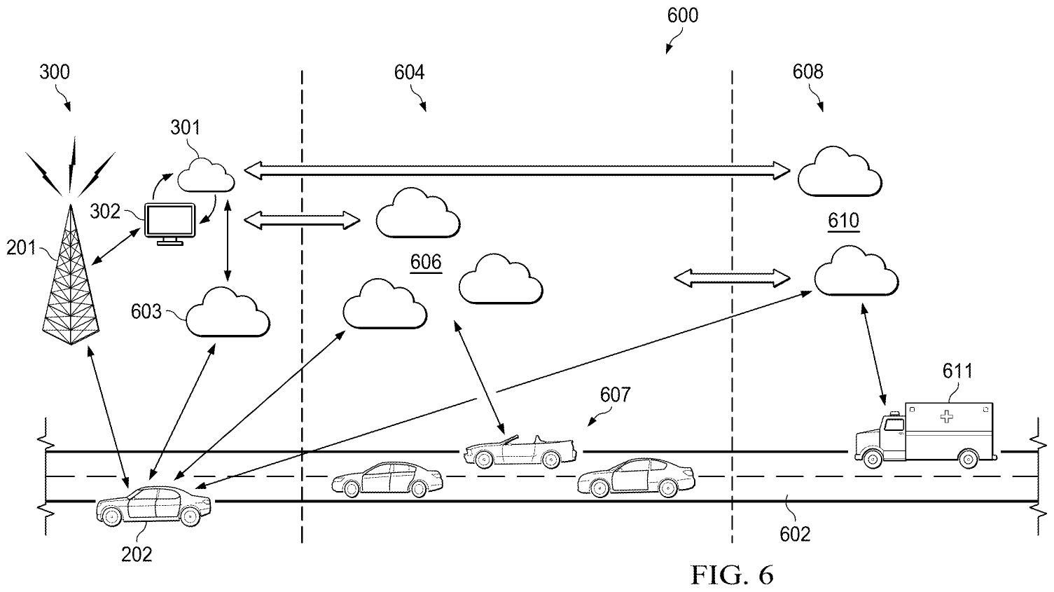

Referring now back to FIG. 6, an environmental level diagram of a vehicle alerting system 300 according to aspects of the present disclosure is shown interacting with third party systems that may provide other types of cloud services to vehicles that may or may not be equipped with hardware of the system 300 (i.e., they may or may not be equipped with a setup 100 as shown in FIG. 1 or similar). For purposes of discussion an operational area 600 may be any geographical region in which one or more systems as shown in FIG. 6 operates. A roadway 602 is shown logically but is not to scale nor configured as an actual roadway may be. Roadway 602 can represent a single lane of a road, an entire roadway, or an entire roadway network or system. Several vehicles 202, 607, 611 are shown, but more or fewer may be present. Some communicative couplings are shown for illustration as lines with arrowed ends, but those of skill in the art will appreciate that these are simplified, and the actual communicative couplings may be more complex and more numerous than shown.

The operational area 600 may be divided into a number of logical domains shown divided by dotted lines. Physically the domains may overlap. The vehicle alerting system 300 may include alert management system 302 (which may be a cloud computing system accessible via the Internet 301 or another network). A single disabled vehicle 202 is shown for illustration but it should be understood that the alert management system 302 would be interacting with and tracking multiple vehicles, disabled or otherwise, that are reporting alerts based on any of the bases discussed herein, or others. The vehicles (represented here by vehicle 202) may communicate with the alert management system 302 by any suitable communicative coupling, such as a wireless network represented by tower 210.

Systems and methods of the present disclosure may equip vehicles to automatically or manually report road hazard or other events to a cloud, such as an OEM cloud 603. The OEM cloud may represent a component of systems and methods of the present disclosure and may provide for vehicle-to-vehicle communication as described herein. In some embodiments, the OEM cloud is a service and/or equipment provided by the original vehicle manufacturer as part of a safety suite, for example. Such clouds 603 or wireless networks can be interfaced to the alert management system 302 of the present disclosure to aid in providing the functionality herein. In this way, systems and methods of the present disclosure can augment those provided at an OEM level without supplanting or replacing other services (e.g., general direction finding, convenience services, system upgrades etc.). In FIG. 6, the OEM cloud is shown interacting with the alert management system via the Internet 302 but it should be understood that additional or different communicative links or couplings may be used.

An aftermarket cloud services domain 604 may contain one or more mobile enabled services shown generally at 606. These may include, without limitation, services such as Google Maps®, Waze®, Tomtom®, and others. Services that provide mapping information and other data to/from vehicles 607 can benefit from alerts generated by systems and methods of the present disclosure even if they are servicing only vehicles 607 that are not directly associated with the alert management system 302. In some cases, the system 100 as provided on the vehicle 202 may be configured to provide an alert directly to a third-party mobile service such as those shown at 606. In addition, or instead, an alert may be forwarded to one of these networks for distribution by the alert management system 302. If the networks 606 track and provide location information for cars within their domain, the emergency alert system 302 can even take such information to account as described above when determining which alerts should be distributed. This can be indicated by communication to the services 606 to further distribute. Therefore, systems and methods of the present disclosure can also augment services that may already be available to customers of third party providers.

Similarly, vehicle 202 may provide alerts or data to emergency services cloud systems shown at 610. Again, this may occur directly or via the alert management system 302. Alerts from third party systems 606 can also be forwarded to emergency services systems 610. Alerts, including location and other data, can be provided to aid in dispatching, for example, an ambulance service 611, but also to aid fire, police, and other emergency response services. Emergency broadcast services may also receive alerts for rebroadcast, with the rebroadcast possibly being limited to particular areas or roadways.

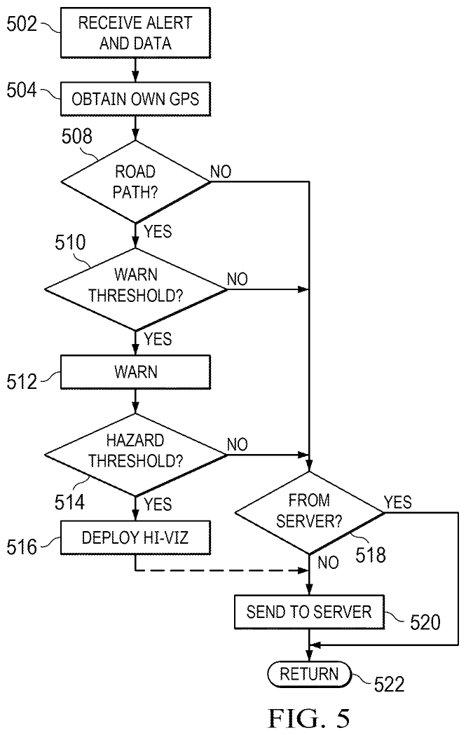

Referring now back to FIG. 5, a flow chart 500 corresponding to one method of operation of an alert system according to aspects of the present disclosure is shown. The chart 500 illustrates a potential flow of operations when a system according to the present disclosure (e.g., 100, 300) receives notification that another vehicle has encountered a hazardous condition. At step 502 the system 100 receives the hazard/emergency notification (for clarification, in the present context, the vehicle where the method of flow chart 500 is executed has received an alert generated by another vehicle and provided by that vehicle, or received from, for example, the emergency alert service 302). At step 504 the system obtains its own GPS location data (e.g., from GPS unit 125). At step 508 the microprocessor 102 may determine whether the GPS location of the alerting vehicle, contained in the alert itself, represents a location that is on its own road pathway. For purposes of this disclosure a road pathway would be the roadway the receiving vehicle is travelling on, considering the direction, or on a side road, the turn, exit, etc. that the vehicle is likely to take.

If yes (the alerting vehicle is on the receiving vehicle's road pathway), the system may additionally determine if the broadcasting vehicle is within a threshold that requires warning the driver or vehicle immediately at step 510. This determination may be based on speed limit, actual vehicle speed, time or day, road conditions, etc. For example, warning a driver of a received hazard alert from another vehicle when the receiving vehicle is already stopped, is parked, or on an adjacent roadway may not be helpful. However, a low threshold warning could still be given (a non-emergency cautionary indication inside the car, for example).

If the broadcasting vehicle is within the threshold, an appropriate warning (e.g., visual and/or audible) may be provided at step 512. This may be both to the driver of the vehicle and to the vehicle itself (e.g., via CAN bus, or other connection). The alert may be used by auto control systems of the vehicle to stop cruise control or take other precautionary actions, or by self-driving systems to prepare to stop, reroute, etc.

A second threshold may be checked at step 514 to determine if the receiving vehicle itself is now in a hazardous state or near to a hazardous condition. This may be based on position in the roadway from GPS, camera, or other data, general conditions, proximity to the broadcasting vehicle and other factors. At step 514, if the system 100 determines it is warranted, the receiving vehicle may activate its own high conspicuity visual display systems (e.g., strobing indicators or flashers).

If the broadcasting vehicle is not on the receiving vehicle's road pathway (step 508), and is not within the warning threshold (step 510) or hazard threshold (step 514) the system may nevertheless determine at step 518 if the broadcast warning was received from its own connected server (e.g., sever 302). If not (e.g., the signal was received only directly from the broadcasting vehicle, wirelessly, via light sensors, etc.) the system may forward the hazardous condition alert to its own server at step 520. Thus, the broadcast event becomes available to other vehicles interfaced with server 302 (or others connected as discussed with respect to FIG. 6). If the system deploys its own high conspicuity visual display system, it may also report this to the server at step 302 as this is indicative the originally broadcast hazard condition may have expanded or propagated.

It is to be understood that the terms “including”, “comprising”, and grammatical variants thereof do not preclude the addition of one or more components, features, steps, or integers or groups thereof and that the terms are to be construed as specifying components, features, steps or integers. It should also be understood that the illustrated and describe embodiments may have additional components that are not shown and are not intended to be excluded by their absence. However, other embodiments contain only those components explicitly references and other components and functions are therefore excluded. Not all components and steps that would easily be grasped and understood to be present by one of skill in the art are necessarily explicitly described or illustrated.

An operative connection, a communicative coupling, and similar terms indicate that appropriate structure may be present to provide the stated function.

If the specification or claims refer to “an additional” element, that does not preclude there being more than one of the additional elements.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A system for communicating alerts to or from a passenger vehicle comprising:
a microprocessor in the vehicle receiving an indication of a hazard event associated with a first passenger vehicle and generating an alert in response thereto; and
a transmitter used by the microprocessor to forward the alert wirelessly to a safety alert system that forwards the alert to one or more additional passenger vehicles determined to be in an approach zone to a location where the microprocessor received the indication of the hazard event.

2. The system of claim 1, wherein the hazard event comprises an indication that the first passenger vehicle is not safely operable.

3. The system of claim 1, wherein the hazard event comprises an indication of damage to the passenger vehicle.

4. The system of claim 1, wherein the indication of the hazard event originates from a passenger vehicle safety system.

5. The system of claim 1, wherein the indication of the hazard event is from an occupant of the passenger vehicle.

6. The system of claim 1, wherein the alert includes data corresponding to the location of the passenger vehicle.

7. The system of claim 6, wherein the alert includes data corresponding to an orientation of the passenger vehicle.

8. The system of claim 1, wherein the microprocessor generates and sends to the safety alert system via the transmitter an additional alert containing additional information related the hazard event.

9. The system of claim 1, wherein the transmitter is a radiofrequency transmitter.

10. A method comprising:
providing a safety alert server in communication with a plurality of passenger vehicles;
receiving at the safety alert server from a first of the plurality of passenger vehicles an indication that the first passenger vehicle has encountered a hazard and a location of the first passenger vehicle;
obtaining location and heading information at the safety alert server from at least some of the plurality of passenger vehicles apart from the first of the plurality of passenger vehicles; and
determining at the safety alert server if any of the at least some of the plurality of passenger vehicles apart from the first of the plurality of passenger vehicles is within a predetermined distance of and headed toward the first of the plurality of passenger vehicles, and if so, sending an alert to such of the at least some of the plurality of passenger vehicles apart from the first of the plurality of passenger vehicles.

11. The method of claim 10, further comprising delivering the alert via the internet.

12. The method of claim 10, further comprising delivering the alert wirelessly.

13. The method of claim 10, further comprising sending the alert from the safety alert server to a cloud computing platform.

14. The method of claim 10, further comprising sending the alert from the safety alert server to an emergency responder service.

15. The method of claim 10, further comprising:
receiving at the safety alert server an indication of a hazard at a fixed location not originating from a passenger vehicle;
determining at the safety alert server if any of the at least some of the plurality of passenger vehicles is within a predetermined distance of and headed toward the fixed location, and, if so, sending a notification to such of the at least some of the plurality of passenger vehicles.

16. The method of claim 15, further comprising:
obtaining at the safety alert server driving characteristic data from at least a subset of the plurality of passenger vehicles;
determining by the safety alert server an inferred hazard location based on the received driving characteristic data;
sending an alert from the safety alert server to at least one of the plurality of passenger vehicles with a heading in a direction of the inferred hazard location.

17. A system comprising:
a first a microprocessor in a first passenger vehicle; and
a safety alert system having a communicative coupling to the first microprocessor;
wherein the first microprocessor provides location data regarding the vehicle to the safety alert system; and
wherein the safety alert system sends an inbound safety alert to the first microprocessor when the location data indicates the first passenger vehicle is nearing a safety hazard.

18. The system of claim 17, wherein the safety alert system is notified of the safety hazard by a second passenger vehicle to which is it communicatively coupled.

19. The system of claim 17, wherein the first microprocessor issues a command to the vehicle to disengage a driving assist feature and provide a notice to a driver of the vehicle when the inbound safety alert is received.

20. The system of claim 17, wherein the first microprocessor is communicatively coupled to a safety system of the first passenger vehicle, and in response to an indication of a vehicle safety hazard send an outbound alert to the safety alert system.
